(19) United States
(12) Patent Application Publication
(10) Pub. No.: US 2026/0357368 A1
(43) Pub. Date: Nov. 12, 2026

(54) PROCESS FOR RECOVERING METALS FROM WASTE MATERIALS AND ORES

(71) Applicant: FLASH METALS USA INC., Houston, TX (US)

(72) Inventors: Clifton T. KNIGHT, League City, TX (US); Aaron KNIGHT, League City, TX (US); Luis RODRIGUEZ, Katy, TX (US); David CARPENCY, Webster, TX (US); Steven RAGIEL, Houston, TX (US)

(21) Appl. No.: 19/450,178

(22) Filed: Jan. 15, 2026

Related U.S. Application Data
(60) Provisional application No. 63/101,198, filed on Jan. 22, 2025.
(60) Provisional application No. 63/924,103, filed on Nov. 24, 2025.

(51) Int. Cl. C22B 1/08; B01D 5/00; C01B 9/02; C25C 1/12

(52) U.S. Cl. CPC C22B 1/08; B01D 5/0036; C01B 9/02; C25C 1/12

(57) ABSTRACT

A process for recovering metals that includes forming a processed feedstock, the processed feedstock including a first metal. The process also includes halogenating the processed feedstock at a first halogenating temperature to form a first gaseous metal halide stream. The first gaseous metal halide stream has a first metal halide and the first halogenating temperature is selected based on the first metal. In addition, the process includes condensing a first portion of the first gaseous metal halide stream at a first condensing temperature. The first condensing temperature is based on a first gaseous metal halide in the first gaseous metal halide stream.

### CROSS-REFERENCE TO RELATED APPLICATIONS

This application is a nonprovisional application which claims priority from U.S. provisional application Nos. 63/101,198, filed Jan. 22, 2025, and 63/924,103, filed Nov. 24, 2025, each of which is incorporated by reference herein in its entirety.

### TECHNICAL FIELD/FIELD OF THE DISCLOSURE

The present disclosure relates generally to processing of materials containing metals.

### BACKGROUND OF THE DISCLOSURE

There are many different traditional methods of separating metals from such starting materials as ores, mine tailings, manufacturing and production scrap, waste streams, recycle streams, electronic waste, and black mass. These traditional methods often have low efficiencies in that much of the metal may be left in the starting materials. Traditional methods consume significant amounts of energy, acid/base reagents, and water and are often environmentally toxic. Thus, such traditional methods may result in valuable metals being unrecovered and toxic ending materials.

### SUMMARY

The disclosure includes a process for recovering metals that includes forming a processed feedstock, the processed feedstock including a first metal. The process also includes halogenating the processed feedstock at a first halogenating temperature to form a first gaseous metal halide stream. The first gaseous metal halide stream has a first metal halide, and the first halogenating temperature is selected based on the first metal. In addition, the process includes condensing a first portion of the first gaseous metal halide stream at a first condensing temperature. The first condensing temperature is based on a first gaseous metal halide in the first gaseous metal halide stream.

The disclosure also includes a process for recovering metals. The process includes forming a processed feedstock, the processed feedstock including a first metal and halogenating the processed feedstock at a halogenating temperature to form a gaseous metal halide stream. The gaseous metal halide stream has a first metal halide and a second metal halide. Further, the process includes distilling the gaseous metal halide stream to form a first fraction having the first metal halide and a second fraction having the second metal halide, wherein the first metal halide and the second metal halide are molten.

In addition, the disclosure includes a process for recovering metals. The process includes halogenating a processed feedstock at a halogenating temperature to form a gaseous metal halide stream, the gaseous metal halide stream having a first metal halide and a second metal halide. The process also includes condensing a first portion of the gaseous metal halide stream at a condensing temperature, the condensing temperature based on the first metal halide. In addition the process includes quench cooling a second portion of the gaseous metal halide to form a brine containing the second metal halide.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a block flow diagram of a metals treatment process consistent with certain embodiments of the present disclosure.

FIG. 2 is a block flow diagram of a metals removal process consistent with certain embodiments of the present disclosure.

FIG. 3A is a side view of a portion of a semi-batch reactor system consistent with certain embodiments of the present disclosure.

FIG. 3B is a perspective view of the portion of a semi-batch reactor system shown in FIG. 3A.

FIG. 4A is a cross-sectional view of an inductive heating reactor consistent with certain embodiments of the present disclosure.

FIG. 4B is a close-up view of the inductive heating reactor of FIG. 4A.

FIG. 5A is a cross-sectional view of an inductive/ohmic heating reactor consistent with certain embodiments of the present disclosure.

FIG. 5B is a close-up view of the inductive/ohmic heating reactor of FIG. 5A.

FIG. 6A-6C illustrate process steps of heating reactor consistent with certain embodiments of the present disclosure.

FIG. 7A is a perspective view of an outgassing manifold consistent with certain embodiments of the present disclosure.

FIG. 7B is a close-up view of a portion of the outgassing manifold of FIG. 7A.

FIG. 8 is a cross-sectional view of a continuous inductive heating reactor consistent with certain embodiments of the present disclosure.

FIG. 9 is a perspective view of a downstream washing unit consistent with certain embodiments of the present disclosure.

FIG. 10 is a block flow diagram of a process for recovering metals consistent with certain embodiments of the present disclosure.

FIG. 11 is a block flow diagram of a process for recovering metals consistent with certain embodiments of the present disclosure.

FIG. 12 is a block flow diagram of a process for recovering metals consistent with certain embodiments of the present disclosure.

FIG. 13a is a block flow diagram of a process for recovering metals consistent with certain embodiments of the present disclosure.

FIG. 13b is a block flow diagram of a process for recovering metals consistent with certain embodiments of the present disclosure.

FIG. 14 is a block flow diagram of a process for recovering metals consistent with certain embodiments of the present disclosure.

FIG. 15 is a process flow diagram of a metal extraction process consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

In certain embodiments of the present disclosure, a metal extraction process is described that uses inductive heating or inductive and ohmic heating to convert target metals in a feedstock into gaseous form. The metal extraction process may be continuous or semi-batch operations. In some embodiments using the metal extraction process, heat transfer and fluidization mechanisms may be used to achieve efficient reaction kinetics. In some embodiments, the feedstock may be combined within a reactor that uses inductive heating or inductive and ohmic heating with a halogen gas, such as fluorine or chlorine. In some embodiments, additives may be introduced to control the reaction. For example, carbon may be used as an oxygen-reducing agent for highly stable compounds. Examples of such carbon include carbon black or carbonized products such as carbonized wood chips or carbonized coconut hulls. In some embodiments, silicon may be used for retarding the formation of certain products.

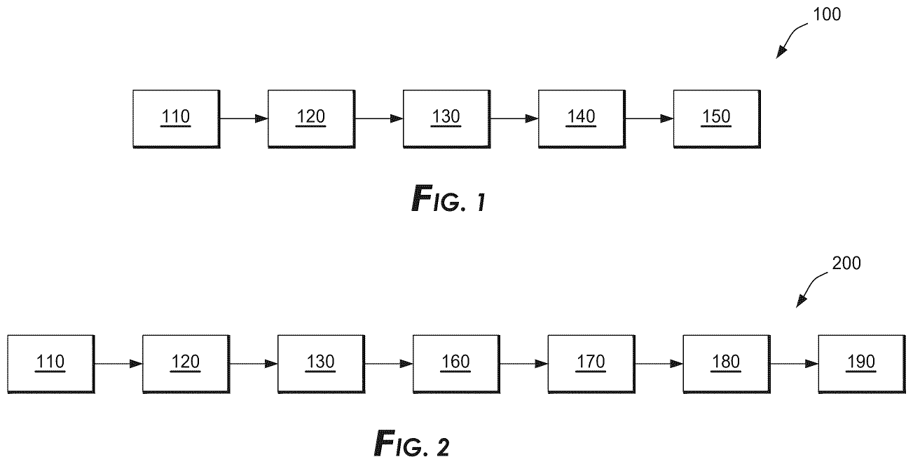

FIG. 1 is a block flow diagram of metal treatment process 100. In certain embodiments, a feedstock containing a metal may be introduced to metal treatment process 100. Examples of such feedstocks may include ores, electronic waste, black mass, lanthanide concentrate, spodumene, bauxite residue (for example, red mud), coal fly ash, gold tailings, rare earth element tailings and fines, and production scrap from processes utilizing indium, gallium, or germanium. As used herein, “black mass” refers to material recovered from end-of-life lithium-ion batteries during recycling. For example, rare earth element tailings and fines may be formed in mining and concentrating of rare earth bearing minerals, such as, for example and without limitation, bastnasite, monazite, ionic clay, and eudialyte. Such rare earth tailings and fines may include between, for example, 200 ppm and 25% by weight of a rare earth element, such as terbium, dysprosium, neodymium, Praseodymium, and scandium. In some embodiments, the feedstock may be crushed or ground to increase surface area of the feedstock in feedstock grinding step 110 to form ground feedstock. In some embodiments, the ground feedstock may be dried in feedstock drying step 120 to form a dried feedstock. As one of ordinary skill in the art with the benefit of this disclosure will appreciate, feedstock drying step 120 and feedstock grinding step 110 may be reversed. In certain embodiments, feedstock grinding step 110, feedstock drying step 120, or both may be omitted.

Following either feedstock drying step 120 or feedstock grinding step 110 when used, the dried feedstock or ground feedstock may be fluidized, such as in a semi-batch reactor, or combined with a carrier fluid, such as in a continuous reactor in combine with carrier/fluidize step 130. The fluidization medium or carrier fluid may be any suitable material, for example and without limitation, argon. Following fluidization or combination with a carrier, the ground and dried feedstock may be heated in an inductive heating reactor or inductive/ohmic heating reactor in heat reactants step 140. Ohmic heating may also be described as flash Joule heating. In heat reactants step 140, the reactor may be heated through inductive heating or a combination of inductive and ohmic heating to a temperature range that causes metals in an acid-resistant or otherwise resistant state to break up and form a less-acid-resistant compound. Metals in this acid-resistant state may be sourced, for example and without limitation, from a refractory. Without being bound by theory, the resulting metal compound may be an oxide or other acid-penetrable form. The metal may then be cooled and recovered in cooling step 150.

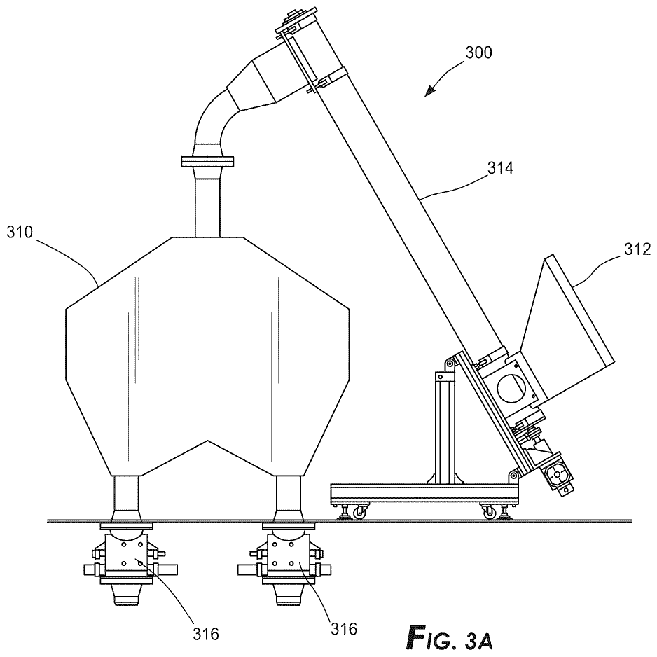

FIG. 2 depicts metal extraction process 200. In certain embodiments of metal extraction process 200, a feedstock containing a metal may be introduced. Examples of such feedstocks may include ores, electronic waste, black mass, lanthanide concentrate, spodumene, bauxite residue (for example, red mud), coal fly ash, gold tailings, rare earth element tailings and fines, and production scrap from processes utilizing indium, gallium, or germanium. For example, rare earth element tailings and fines may be formed in mining and concentrating of rare earth bearing minerals, such as, for example and without limitation, bastnasite, monazite, ionic clay, and eudialyte. Such rare earth tailings and fines may include between, for example, 200 ppm and 25% by weight of a rare earth element, such as terbium, dysprosium, neodymium, Praseodymium, and scandium. As used herein, “black mass” refers to material recovered from end-of-life lithium-ion batteries during recycling. In some embodiments, the feedstock may be crushed or ground as described above or these steps may be omitted.

Following either feedstock drying step 120 or feedstock grinding step 110 when used, the dried feedstock or ground feedstock may be fluidized, such as in a semi-batch reactor, or combined with a carrier fluid, such as in a continuous reactor in combine with carrier/fluidize step 130. The fluidization medium or carrier fluid may be any suitable material, for example and without limitation, a halogen gas, a noble gas such as argon, or a combination thereof. Following fluidization or combination with a carrier, the ground and dried feedstock may be heated and reacted with a halogen gas and metal to form gaseous metal halides in reaction step 160. Without being bound by theory, this reaction may proceed as follows, with chlorine shown as a non-limiting example of a halogen gas:

MX+Cl₂→MCl+X

As a specific example, when reacting spodumene with chlorine gas:

LiAlSi₂O₆(β)+½Cl₂(g)→LiCl+⅙Al₆Si₂O₁₃+5/3SiO₂(CRS)+¼O₂(g)

Reaction step 160 may be performed continuously or semi-batch. Reaction temperature may be controlled, for example, based on the metal to be recovered. For example, certain feedstocks may include multiple metals. Because different metals react with the halogen gas in different temperature ranges, in certain embodiments, the reaction temperature may be adjusted to a first temperature reaction range, for example, to capture a first metal and then adjusted to a second temperature reaction range to capture a second metal. In others, multiple reactors may be used and may operate at different temperature ranges. By operating in certain temperature ranges high value metals may be selected while minimizing non-targeted reactions. As non-limiting examples, metals such as aluminum, magnesium, and lithium form metal halides at approximately 250 °C. In contrast, more thermally stable metals, such as titanium and tantalum, may require higher temperatures, such as about 1800 °C for halogenation.

In both semi-batch and continuous reaction, after reaction step 160, metal halide off gas may be captured in metal halide off gas capture 170. The metal halides may be washed in metal halide wash 180 and condensed in brine condensation 190.

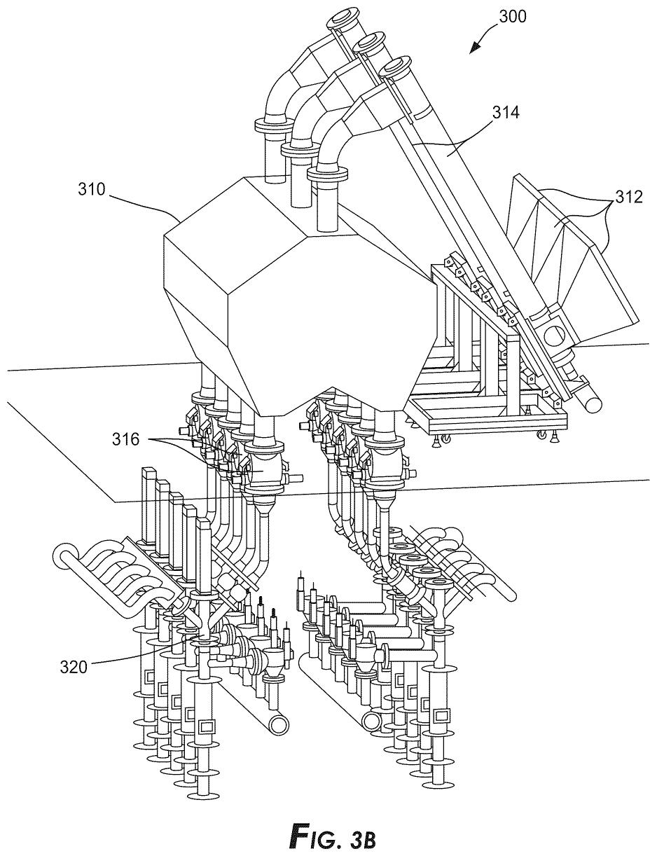

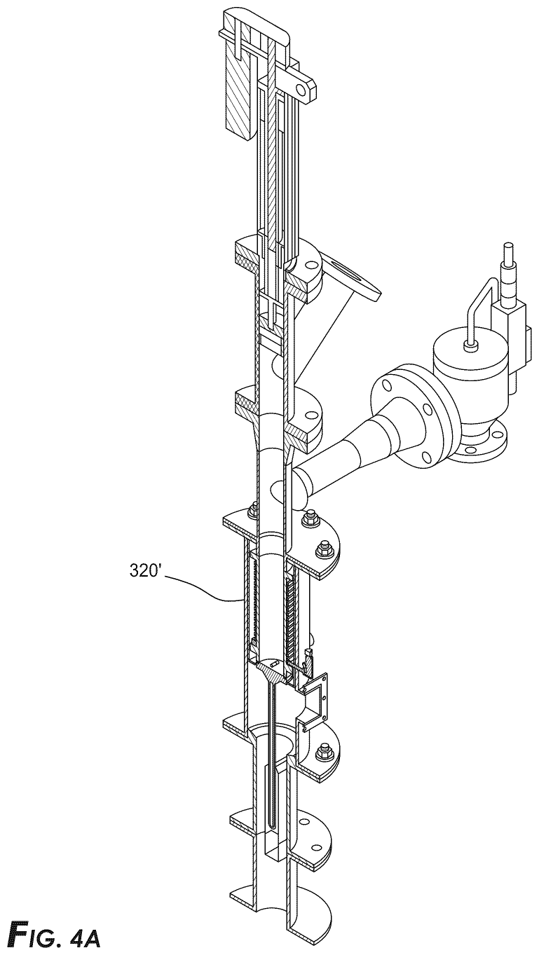

FIGS. 3A and 3B depict examples of semi-batch reactor system 300 in accordance with certain embodiments of the present disclosure in which a reaction between the metal and the halide may occur. Semi-batch reactor system 300 may include reactor loading hopper 310. Reactor loading hopper 310 is adapted to contain and deliver feedstock containing metal to one or more reactors 320 to which reactor loading hopper 310 is fluidly connected as shown in FIG. 3B. One or more feed hoppers 312 may be fluidly connected to reactor loading hopper 310. While FIG. 3B shows three feed hoppers 312, one of ordinary skill in the art with the benefit of this disclosure will recognize that any number of feed hoppers 312 may be used. The fluid connection between one or more feed hoppers 312 and reactor loading hopper 310 may be, for example, one or more screw conveyors 314. A separate screw conveyor may connect each feed hopper 312 with reactor loading hopper 310. In some embodiments, delivery from reactor loading hopper 310 to one or more reactors 320 may be controlled by one or more valves 316. One or more valves 316 may be, for example, rotary valves. In certain embodiments, each valve 316 may be connected to a different reactor 320. In certain embodiments, reactor 320 may be lined, such as with a halogen-resistant liner. Examples of such halogen resistant liners include quartz, HFO₂, or ceramic liners.

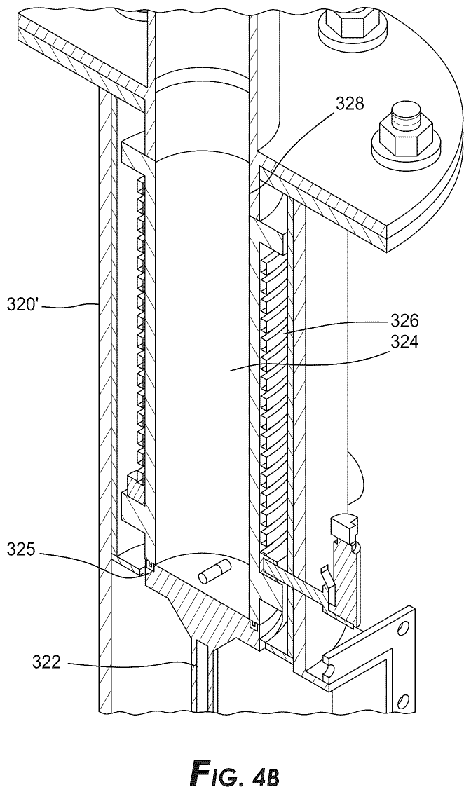

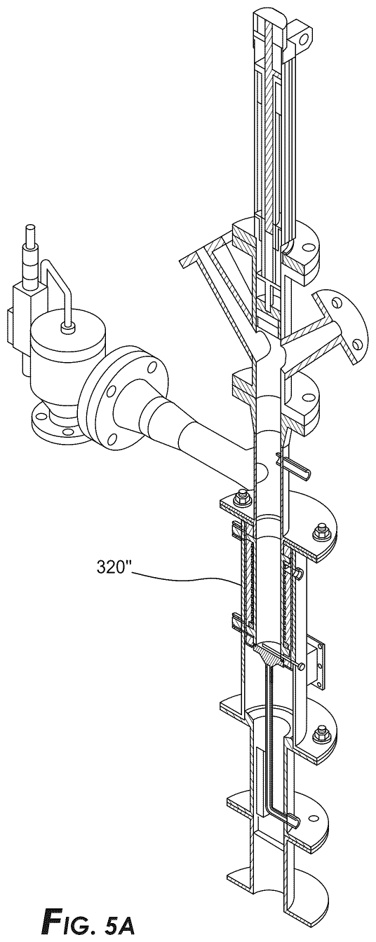

FIGS. 4A and 4B show a cutaway view of inductive heating reactor 320′. Inductive heating reactor 320′ may be a reactor used for one or more reactors 320. The inductive heating reactor 320′ may be used in a semi-batch reaction system. Inductive heating reactor 320′ may include gas inlet 322 in connection with reactor crucible 324. In gas inlet 322, the halogen and the feedstock may be combined and fluidized in the semi-batch reactor. In crucible 324, the reaction between the metal in the feedstock and halogen may take place. Induction coil 326 may be wrapped around crucible 324. In certain embodiments, inductive heating reactor 320′ may be lined, such as with a halogen-resistant liner. Examples of such halogen resistant liners include quartz, HFO₂, or ceramic liners. As current is supplied to induction coil 326, induction coil 326 supplies heat to the crucible 324 to cause the reaction. In some embodiments, diffuser 325 may be positioned at or near the bottom of crucible 324 to disperse the feedstock and halogen reactants. After reaction, the remaining halogen and the metal halide may exit inductive heating reactor 320′ through reactor gas exit 328.

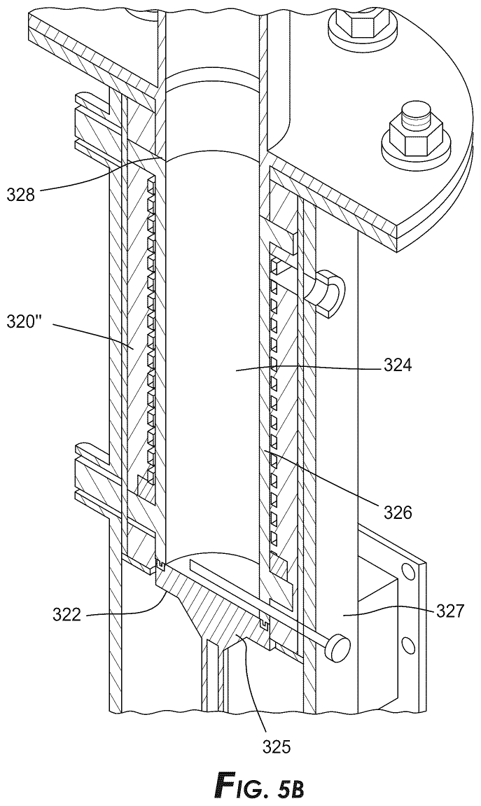

FIGS. 5A and 5B show a cutaway view of inductive/ohmic heating reactor 320″. Inductive/ohmic heating reactor 320″ may be a reactor used for one or more reactors 320. The inductive/ohmic heating reactor 320″ may be used in a semi-batch or batch reaction system. Inductive/ohmic heating reactor 320″ may include gas inlet 322 in connection with reactor crucible 324. When inductive/ohmic heating reactor 320″ is used, at least a portion of inductive/ohmic heating reactor 320″ is metal. In certain embodiments, inductive/ohmic heating reactor 320″ may be lined, such as with a halogen-resistant liner. Examples of such halogen resistant liners include quartz, HFO₂, or ceramic liners. In gas inlet 322, the halogen and the feedstock are combined and fluidized in the semi-batch reactor. In crucible 324, the reaction between the metal in the feedstock and halogen takes place. Induction coil 326 may be wrapped around crucible 324. As current is supplied to induction coil 326, induction coil 326 may supply heat to crucible 324, resulting in reaction of the halogen and the feedstock. Further, crucible 324 may be heated by passing direct current through metal portion 327 of crucible 324. In some embodiments, diffuser 325 may be positioned at or near the bottom of crucible 324 to disperse the feedstock and halogen reactants. After reaction, the remaining halogen and the metal halide may exit inductive heating reactor 320′ through reactor gas exit 328.

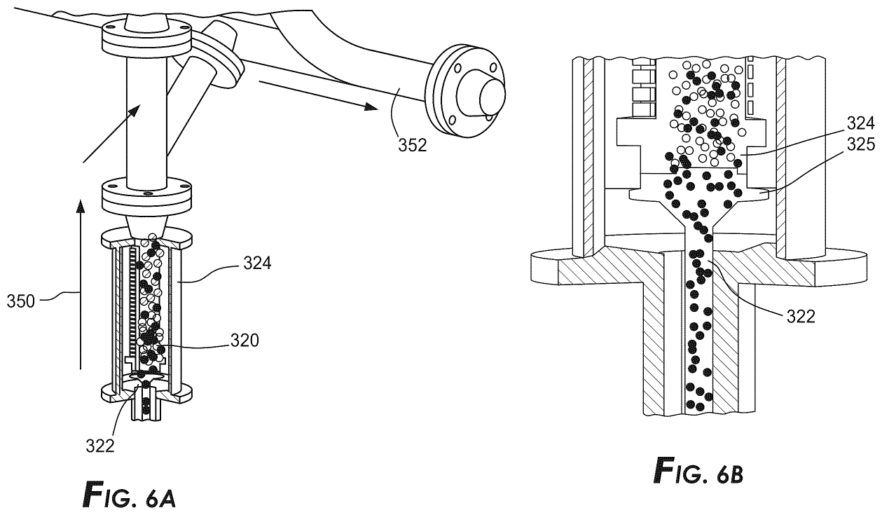

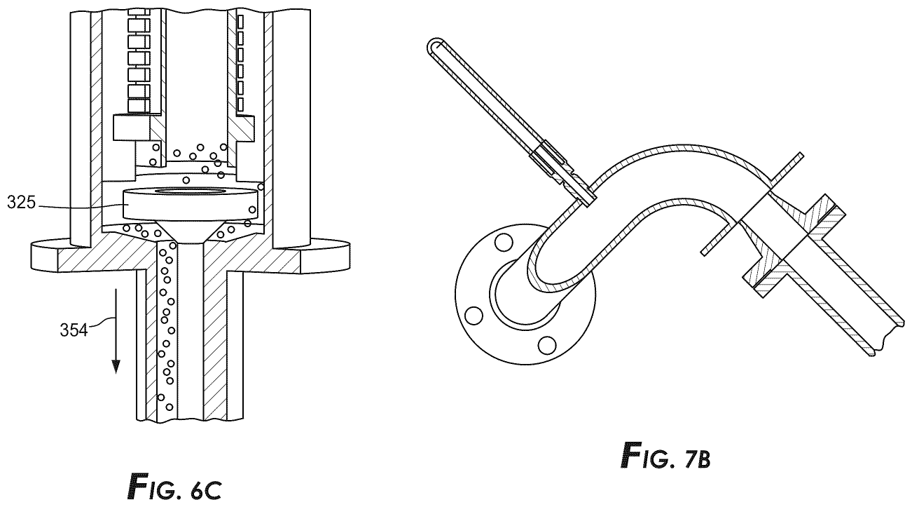

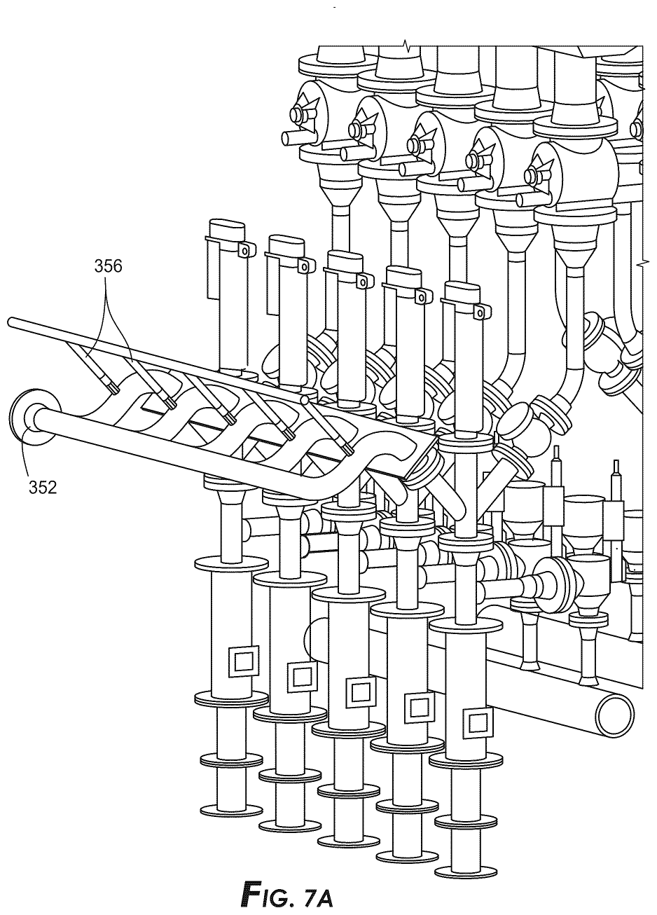

FIGS. 6A, 6B, and 6C depict process steps in the operation of reactor 320 consistent with certain embodiments of the present disclosure. In FIG. 6A, process flow 350 of halogen gas is shown through crucible 324 of reactor 320. In process flow 350, the halogen gas is fluidized, as shown in FIG. 6B by using diffuser 325, which is located at gas inlet 322 of crucible 324. During the reaction, the feedstock, which may be introduced through reactor gas exit 328, is combined with the halogen gas to form metal halides and residual chlorine gas, which exits through outgassing manifold 352, as shown in FIG. 6A. Unreacted feedstock may be discharged from reactor 320 through gas inlet 322 as depicted by discharge 354 after completion of the semi-batch reaction, as shown in FIG. 6C.

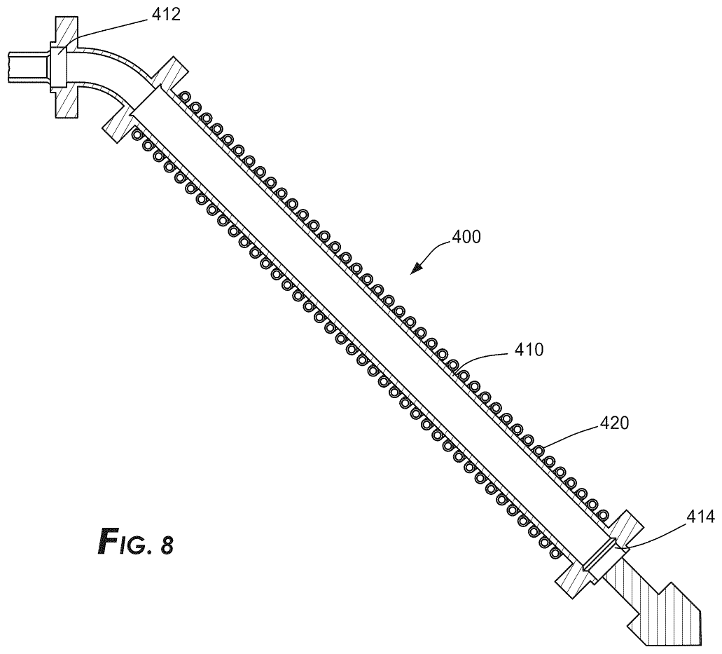

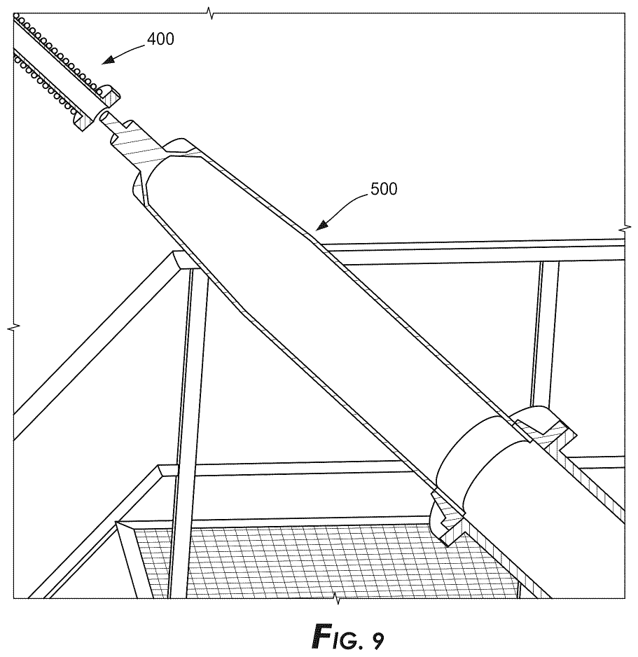

As shown in FIGS. 7A and 7B, outgassing manifold 352 may include water jets 356. Water jets 356 assist in cooling the metal halides and forming the brine.

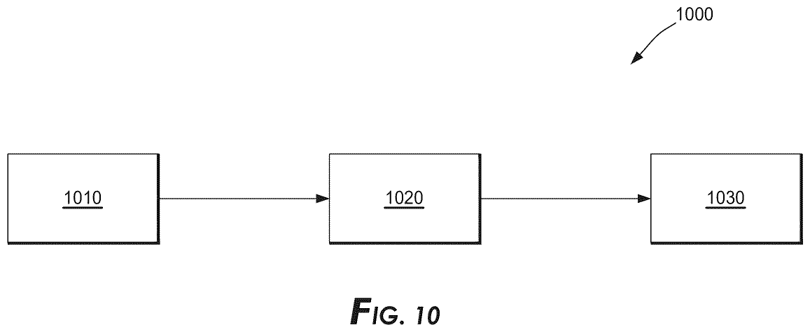

FIG. 8 depicts continuous inductive heating reactor 400 consistent with certain embodiments of the present disclosure. Continuous inductive heating reactor 400 may include reactor body 410, which may be a tube, such as that shown in FIG. 8. Wrapped about reactor body 410 may be one or more induction coils 420. Reactor body 410 may include inlet 412 and outlet 414.

FIG. 9 depicts downstream washing unit 500 in connection with continuous inductive heating reactor 400 consistent with certain embodiments of the present disclosure. In downstream washing unit 500, metal halides from continuous inductive heating reactor 400 are combined with water to form a brine. Unreacted halogen gas may be separated from the brine.

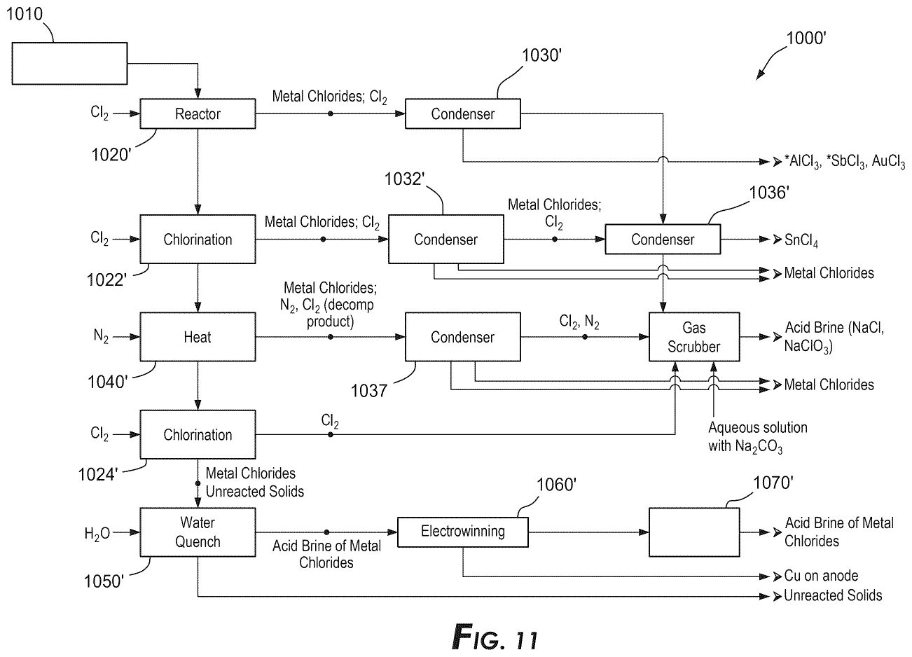

In other embodiments of the present disclosure, as shown in FIGS. 10-14, a process for recovering metals is described that uses inductive heating or inductive and ohmic heating to convert metals in a feedstock into gaseous form. The process for recovering metals may be continuous or a semi-batch operation. In some embodiments, the feedstock may be combined within a reactor that uses inductive heating or inductive and ohmic heating with a halogen gas, such as fluorine or chlorine. In some embodiments, additives may be introduced to control the reaction. For example, carbon may be used as an oxygen-reducing agent for highly stable compounds. Examples of such carbon include carbon black or carbonized products such as carbonized wood chips or carbonized coconut hulls. In some embodiments, silicon may be used for retarding the formation of certain products.

FIG. 10 depicts a block flow diagram of one embodiment of process for recovering metals 1000. In certain embodiments, a feedstock containing a metal may be introduced to process for recovering metals 1000. Examples of such feedstocks may include ores, electronic waste, black mass, lanthanide concentrate, spodumene, bauxite residue (for example, red mud), coal fly ash, gold tailings, rare earth element tailing and fines, and production scrap from processes utilizing indium, gallium, or germanium. For example, rare earth element tailings and fines may be formed in mining and concentrating of rare earth bearing minerals, such as, for example and without limitation, bastnasite, monazite, ionic clay, and eudialyte. Such rare earth tailings and fines may include between, for example, 200 ppm and 25% by weight of a rare earth element, such as terbium, dysprosium, neodymium, Praseodymium, and scandium. In some embodiments, process for recovering metals may include feedstock processing step 1010, which may be used to form a processed feedstock. Feedstock processing step 1010 may include shredding, drying, or pyrolysis of the feedstock. In some embodiments, feedstock processing step 1010 may include fluidizing the feedstock, such as with an inert gas. One example of such an inert gas is argon.

Following feedstock processing in feedstock processing step 1010, the processed feedstock may be heated and combined with a halogen gas in one or more inductive heating reactors or inductive/ohmic heating reactors, or combinations thereof in halogenation step 1020 to form gaseous metal halides. Ohmic heating may also be known as flash Joule heating. In halogenation step 1020, the reactor may heat the processed feedstock through inductive heating or a combination of inductive and ohmic heating. In certain embodiments, the pressure for halogenation step 1020 may be adjusted to volatilize the metal halides to form gaseous metal halides.

Without being bound by theory, the reaction of the halogen and the metal may proceed as described above. Halogenation step 1020 may be performed continuously or semi-batch. Semi-batch, as used herein, refers to a process where reactants are added to the one or more reactants over time. The halogenation temperature in halogenation step 1020 may be controlled, for example, based on the metal to be recovered. For example, certain feedstocks may include multiple metals or groups of metals that form gaseous metal halides at different temperatures. Because different metals or groups of metals react with the halogen gas in different temperature ranges, in certain embodiments, the reaction temperature may be adjusted to a first reactor temperature, for example, to halogenate a first metal or set of metals and then adjusted to a second reactor temperature that is higher than the first reactor temperature to halogenate a second metal or second set of metals. In other embodiments, a first inductive heating reactor or inductive/ohmic heating reactor may be operated at the first reactor temperature at which certain metals may be halogenated, and a second inductive heating reactor or inductive/ohmic heating reactor may be operated at a second reactor temperature that is higher than the first temperature at which certain other metals may be halogenated.

Following the formation of the gaseous metal halides in halogenation step 1020, the gaseous metal halides may be cooled in condensation step 1030. In some embodiments, condensation step 1030 may be performed in multiple condensers. In some embodiments, the condenser(s) used in condensation step 1030 may be a plate condenser. In other embodiments, the condenser(s) used in condensation step 1030 may be a shell and tube, spray/quench, graphite block, falling film, packed bed, cold trap, or ceramic tube condenser. In condensation step 1030, the gaseous metal halides may be cooled to form liquid metal halides or solid metal halides. When a plate condenser is used, the liquid or solid metal halides may form on the condenser plates. The liquid metal halides may be drained. Solid metal halides may be scraped or removed via a high-pressure water process, such as hydroblasting, from the condenser plates.

As one of ordinary skill in the art will appreciate with the benefit of this disclosure, in certain embodiments such as where multiple different gaseous metal halides are present in condensation step 1030, multiple condensers may be used in condensation step 1030. For example, a first condenser at a first condensation temperature may be used and in a second condenser in series with the first condenser, a second condensation temperature that is lower than the first condensation temperature may be used. In other embodiments where multiple different gaseous metal halides are present, a single condenser may be used with condenser plates within the single condenser at different condensation temperatures. In such embodiments, a first set of condenser plates may be at the first condensation temperature and a second set of condenser plates may be at the second condensation temperature, where the first condensation temperature is higher than the second condensation temperature. In some embodiments where plates of different condensation temperatures are used, the condenser may be arranged vertically, such that the highest temperature plate is at the top of condenser and plate temperatures decrease towards the bottom of the condenser.

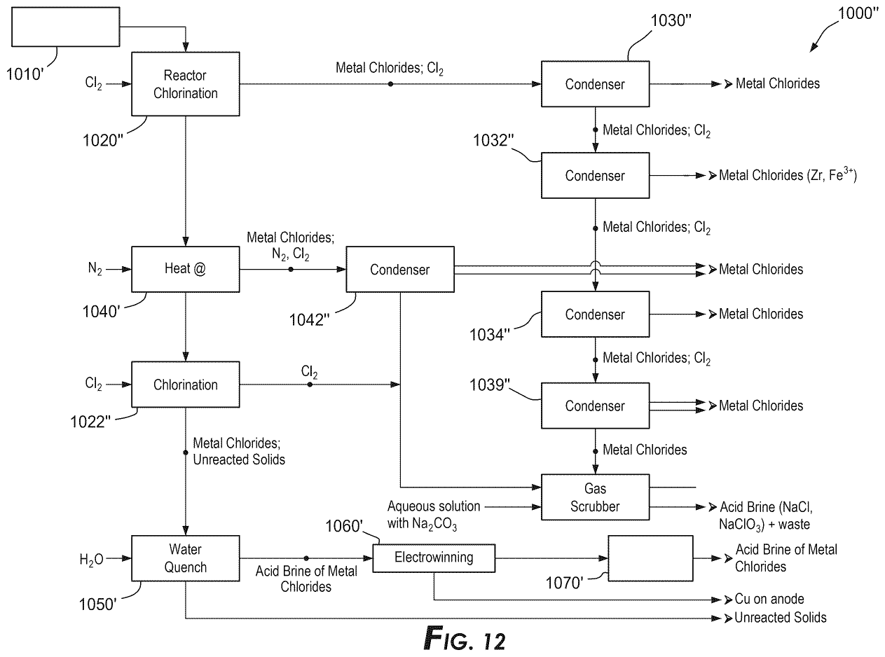

The reaction temperatures and condenser temperatures may be adjusted depending on the feedstock. For example, if a feedstock contained gold and aluminum, gold may form a metal halide at a lower temperature than that of aluminum. In such an example, the first inductive heating reactor or inductive/ohmic heating reactor may be operated at a first reactor temperature to remove the gold from the feedstock in the form of a gold halide, for instance, AuCl₃. The gold halide may then be condensed in a condenser. The aluminum in the feedstock may be halogenated at a second reactor temperature that is higher than the first reactor temperature in a second inductive heating reactor or inductive/ohmic heating reactor or in the first inductive heating reactor or inductive/ohmic heating reactor raised to the second reactor temperature. The gold halide may be cooled in a condensation step at a first condensation temperature and the aluminum halide at a second condensation temperature, where the first condensation temperature is lower than the second condensation temperature. FIG. 11-14 depict specific embodiments of process for recovering metals 1000 consistent with that described for FIG. 10. For example, first halogenation step 1020′, second halogenation step 1022′, and third halogenation step 1024′ as shown in FIG. 11 may operate in the same manner as halogenation step 1020 except as to the differences noted herein.

FIG. 11 is a block flow diagram of a process for recovering metals 1000′ for a particular embodiment of process for recovering metals 1000. In the embodiment shown in FIG. 11, halogenation of the feedstock may be performed in first halogenation step 1020′, second halogenation step 1022′, and third halogenation step 1024′ in the manner described above. First halogenation step 1020′ may be performed at a first halogenation temperature and second halogenation step 1022′ may be performed at second halogenation temperature that is higher than the first halogenation temperature. Third halogenation step 1024′ may be performed at a third halogenation temperature that is higher than the first or second halogenation temperature. By increasing halogenation temperatures, different metals may be halogenated in the different halogenation steps. First halogenation step 1020′, second halogenation step 1022′, and third halogenation step 1024′ may be performed in the same or different reactors.

In certain embodiments, first halogenation step 1020′ may be performed at a first halogenation temperature of between 200 °C and 300 °C or 250 °C. At this first halogenation temperature, gaseous metal chlorides of gold, antimony, tin, and aluminum may be formed and separated from the processed feedstock, where such elements are present in the processed feedstock. Second halogenation step 1022′ may be performed at a second halogenation temperature of between 500 °C and 600 °C or 550 °C. At this second reactor temperature, metal chlorides of zinc and iron may be formed and separated from the processed feedstock where such elements were present in the processed feedstock.

In the non-limiting embodiment shown in FIG. 11, heating step 1040′ may be performed between second halogenation step 1022′ and third halogenation step 1024′. In heating step 1040′, a previously halogenated feedstock may be heated to a heating temperature without introducing additional halogens. Without being bound by theory, by heating the feedstock in heating step 1040′ to a heating temperature above that at which second halogenation step 1022′ is performed, certain compounds in the feedstock may decompose and form metal halides. In some embodiments, heating temperature may be between 1000 °C and 1200 °C or 1100 °C. In such embodiments, the decomposing compounds may include compounds containing zinc, manganese, lead, titanium, and platinum, where such compounds are present in the processed feedstock. Gaseous halides of zinc, manganese, lead, titanium, and platinum may be formed.

Gaseous halides from first halogenation step 1020′, second halogenation step 1022′, and heating step 1040′ may be cooled in condensers to form solid or liquid metal halides. In the non-limiting example shown in FIG. 11, gaseous metal halides from first halogenation step 1020′ may be cooled in first condensation step 1030′, gaseous metal halides from second halogenation step 1022′ may be cooled in second condensation step 1032′, and gaseous metal halides from heating step 1040′ in heating condensation step 1037. First condensation step 1030′, second condensation step 1032′, and heating condensation step 1037 may be performed in the same or different condensers. In certain embodiments, the condensers may be plate spray/quench, graphite block, falling film, packed bed, cold trap, or ceramic tube condensers.

The condensation step temperatures may be adjusted based on the metal halides to be condensed. For example, when the gaseous metal halides from first halogenation step 1020′ are halides of gold, antimony, tin, aluminum, and combinations thereof, first condensation temperature in first condensation step 1030′ may be between 100 °C and 150 °C or 130 °C. This first condensation temperature may cause solid or liquid metal chlorides of gold, antimony, and aluminum to form on plates of the condenser. Where tin is present in the processed feedstock, tin condensation step 1036′ may be used following first condensation step 1030′ as stannous halides may condense at lower temperatures than first condensation step 1030′. For example, tin condensation step 1036′ may be performed at 60 °C

With respect to second condensation step 1032′, when the gaseous metal halides from second halogenation step 1022′ are halides of zinc, iron, and combinations thereof, second condensation temperature in second condensation step 1032′ may be between 100 °C and 150 °C or 140 °C. This second condensation temperature may cause solid or liquid metal chlorides of zinc and iron to form on plates of the condenser. Where tin is present in the processed feedstock, tin condensation step 1036′ may be used following second condensation step 1032′ as stannous halides may condense at lower temperatures than second condensation step 1032'. For example, tin condensation step 1036′ may be performed at 60 °C

In the non-limiting embodiment shown in FIG. 11, third halogenation step 1024′ may follow heating step 1040′ and may be performed at between 500 °C and 700 °C or 600 °C. Such further halogenation may form solid halides of copper, chromium, nickel and magnesium where such elements are present in the processed feedstock. Rather than condense the halides formed in third halogenation step 1024′, as the halides may already be solid, the halides formed in third halogenation step 1024′ may be water quenched in water quench step 1050′ to form an acid brine of halides. In some embodiments, copper may be separated from the acid brine through electroreduction in electrowinning step 1060′. The remaining halides in the acid brine may be dried in drying step 1070′.

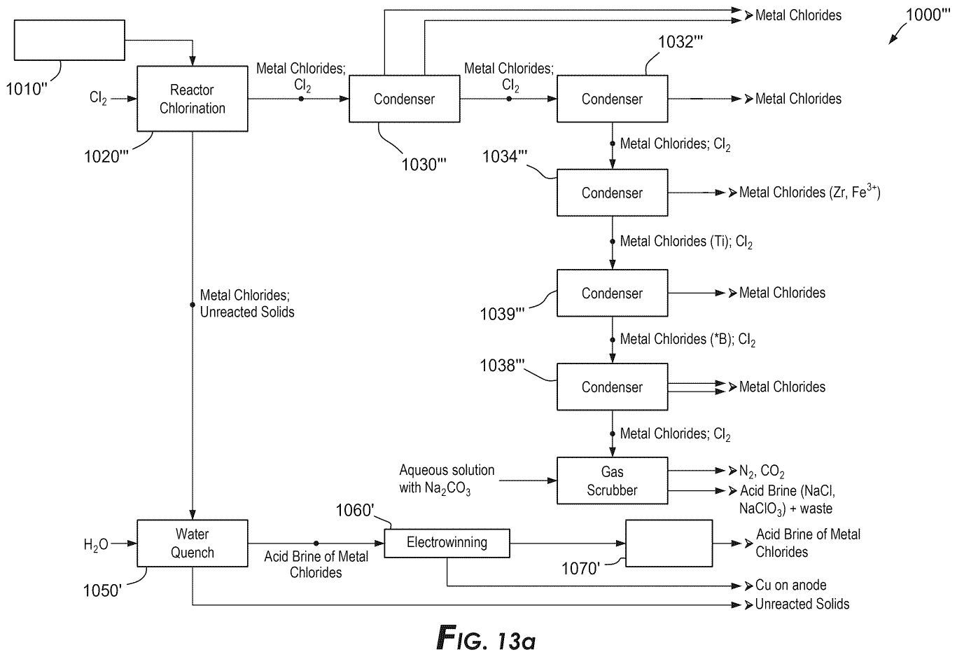

FIG. 12 is a block flow diagram of a process for recovering metals 1000″ for a particular embodiment of process for recovering metals 1000. In the non-limiting embodiment shown in FIG. 12, a halogenation steep may be eliminated and condensation steps may be realigned as compared to the embodiment shown in FIG. 11. Further, halogenation temperatures and condensation temperatures may be different than those described in the embodiment shown in FIG. 11.

Following feedback processing in feedstock processing step 1010′, the processed feedstock may be heated and combined with a halogen gas in one or more inductive heating reactors or inductive/ohmic heating reactors, or combinations thereof. In the embodiment shown in in FIG. 12, halogenation of the feedstock may be performed in first halogenation step 1020″ and second halogenation step 1022″ in the manner described above. First halogenation step 1020″ may be performed at a first halogenation temperature and second halogenation step 1022″ may be performed at second halogenation temperature that is higher than the first halogenation temperature. First halogenation step 1020″ and second halogenation step 1022″ may be performed in the same or different reactors.

In certain embodiments, first halogenation step 1020″ may be performed at a first reactor temperature of between 600 °C and 700 °C or 650 °C. At this first reactor temperature, gaseous metal chlorides of gold, antimony, tin, aluminum, zinc, zirconium, lead, and titanium may be formed and separated from the processed feedstock, where such elements are present in the processed feedstock.

In the non-limiting embodiment shown in FIG. 12, heating step 1040′ may be performed between first halogenation step 1020″ and second halogenation step 1022″. Following heating step 1040′, second halogenation step 1022″ may be performed at a second reactor temperature of between 500 °C and 600 °C or 550 °C. At this second reactor temperature, metal chlorides of copper, chromium, palladium, nickel and magnesium may be formed and separated from the processed feedstock where such elements were present in the processed feedstock. Such further halogenation may form solid halides of copper, chromium, nickel and magnesium where such elements are present in the processed feedstock. The solid halides formed in second halogenation step 1022″ may be water quenched in water quench step 1050′ to form an acid brine of halides. In some embodiments, copper may be separated from the acid brine through electroreduction in electrowinning step 1060′. The remaining halides in the acid brine may be dried in drying step 1070′.

Gaseous halides in a first gaseous halide stream from first halogenation step 1020″ and heating step 1040′ may be cooled in condensers to form solid or liquid metal halides. In the non-limiting example shown in FIG. 12, the first gaseous halide stream from first halogenation step 1020″ may be cooled in staged condensation steps. As shown in FIG. 12, gaseous metal halides from the first gaseous halide stream from first halogenation step 1020″ may be cooled in first condensation step 1030″, second condensation step 1032″, third condensation step 1034″, and fourth condensation step 1039″, although fewer or more condensation steps may be used. First condensation step 1030″, second condensation step 1032″, third condensation step 1034″, fourth condensation step 1039″ and heating condensation step 1042″ may be performed in the same or different condensers. In certain embodiments, the condensers may be plate, spray/quench, graphite block, falling film, packed bed, cold trap, or ceramic tube condensers.

The condensation step temperatures may be adjusted based on the metal halides to be condensed. In certain embodiments, such as the one shown in FIG. 12, the first condensation temperature in first condensation step 1030″ is higher than the second condensation temperature in second condensation step 1032″, which is higher than the third condensation temperature in third condensation step 1034″, which is higher than the fourth condensation step in fourth condensation step 1039″. Each of these condensation temperatures may be adjusted to achieve a particular group of metal chlorides. In a particular embodiment, first condensation temperature may be set to between 500 °C and 600 °C or 550 °C to condense gaseous metal chlorides of lead, platinum and zinc. Second condensation temperature may be set to between 250 °C and 300 °C or 270 °C to condense zirconium and iron. Third condensation temperature may be set to between 175 °C and 325 °C or 300 °C to condense antimony and gold. Fourth condensation temperature may be set to between 60 °C and 100 °C or 80 °C to condense tin, titanium and aluminum. Similarly, heating condensation temperature for heating condensation step 1042″ may be set to between 60 °C and 100 °C or 80 °C to condense zinc, manganese, lead, titanium, platinum, chromium, and iron.

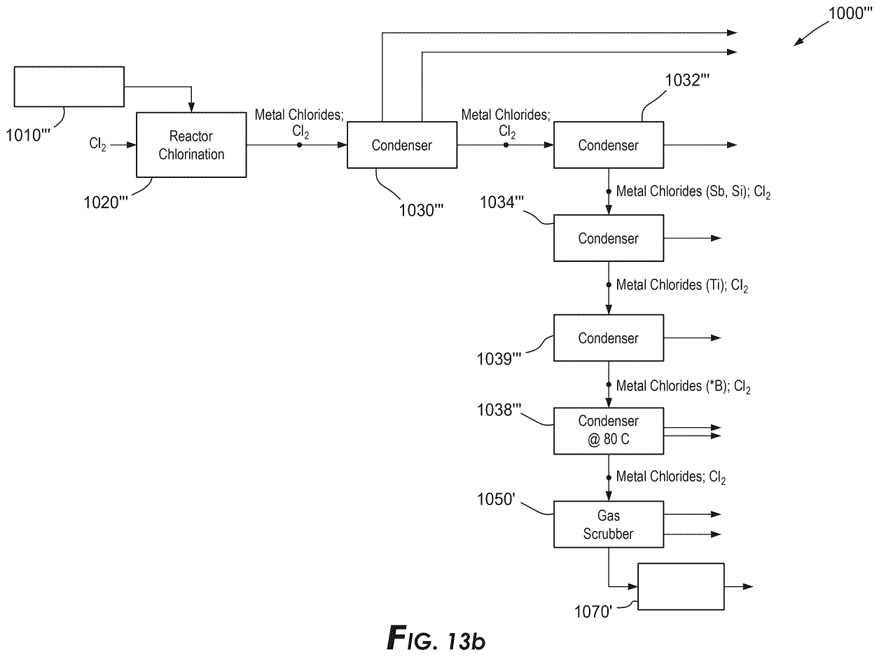

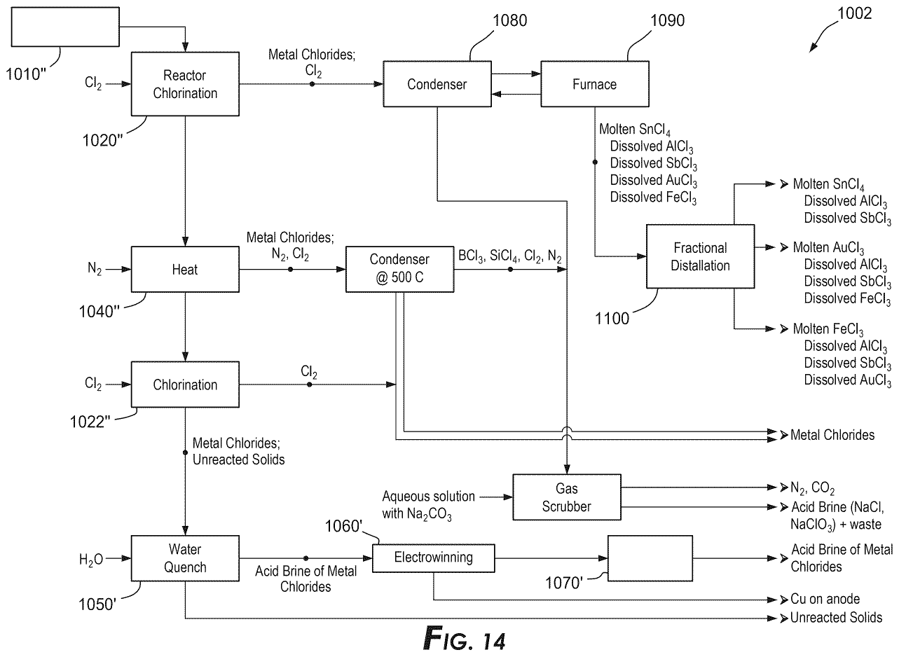

FIG. 13a is a block flow diagram of a process for recovering metals 1000′″ for a particular embodiment of process for recovering metals 1000. In the non-limiting embodiment shown in FIG. 13a, a single halogenation step may be used, which as shown in FIG. 13a is halogenation step 1020′″. Halogenation step 1020″′ may be performed at a halogenation temperature. In certain embodiments, halogenation step 1020″′ may be performed at a halogenation temperature of between 1000 °C and 1400 °C or 1200 °C. At this halogenation temperature, gaseous metal chlorides and solid metal chlorides may be formed. Gaseous metal chlorides formed in halogenation step 1020″′ may include gold, tin, antimony, iron, aluminum, zirconium, lead, platinum, zinc, and manganese. Solid metal chlorides may include magnesium, nickel, copper, chromium and palladium. The gaseous metal chlorides may be separated from the solid metal chlorides.

Gaseous halides in halogenation step 1020″′ may be cooled in condensers to form solid or liquid metal halides. In the non-limiting example shown in FIG. 13a, gaseous metal halides from halogenation step 1020″′ may be cooled in staged condensation steps. As shown in FIG. 13a, gaseous metal halides from halogenation step 1020″′ may be cooled in first condensation step 1030′″, second condensation step 1032′″, third condensation step 1034′″, fourth condensation step 1039″, and fifth condensation step 1038″′, although fewer or more condensation steps may be used. First condensation step 1030″, second condensation step 1032″, third condensation step 1034″, fourth condensation step 1039″ and fifth condensation step 1038″′ may be performed in the same or different condensers. In certain embodiments, the condensers may be plate, shell and tube, spray/quench, graphite block, falling film, packed bed, cold trap, or ceramic tube condensers.

The condensation step temperatures may be adjusted based on the metal halides to be condensed. In certain embodiments, such as the one shown in FIG. 13a, the first condensation temperature in first condensation step 1030″′ is higher than the second condensation temperature in second condensation step 1032″′, which is higher than the third condensation temperature in third condensation step 1034′″, which is higher than the fourth condensation step in fourth condensation step 1039′″, which is higher than fifth condensation temperature in fifth condensation step 1038′″. Each of these condensation temperatures may be adjusted to achieve a particular group of metal chlorides. In a particular embodiment, first condensation temperature may be set to between 700 °C and 900 °C or 800 °C to condense gaseous metal chlorides of zinc, manganese, lead, titanium, platinum, chromium, and iron. Second condensation temperature may be set to between 400 °C and 600 °C or 500 °C to condense lead, platinum, and zinc. Third condensation temperature may be set to between 240 °C and 300 °C or 270 °C to condense zirconium and iron. Fourth condensation temperature may be set to between 180 °C and 220 °C or 200 °C to condense antimony and gold. Fifth condensation temperature may be set to between 60 °C and 100 °C or 80 °C to condense tin, titanium, and aluminum.

The solid halides formed in halogenation step 1020″′ may be water quenched in water quench step 1050′ to form an acid brine of halides. In some embodiments, copper may be separated from the acid brine through electroreduction in electrowinning step 1060′. The remaining halides in the acid brine may be dried in drying step 1070′.

FIG. 13b is a block flow diagram of a process for recovering metals 1000′″ for a particular embodiment of process for recovering metals 1000. In the non-limiting embodiment shown in FIG. 13b, a single halogenation step may be used, halogenation step 1020′″. Following feedback processing in feedstock processing step 1010′″, the processed feedstock may be heated and combined with a halogen gas in a single inductive heating reactors or inductive/ohmic heating reactor. Halogenation step 1020″′ may be performed at a halogenation temperature. In certain embodiments, halogenation step 1020″′ may be performed at a halogenation temperature of between 1000 °C and 1400 °C or 1200 °C. At this halogenation temperature, gaseous metal chlorides may be formed.

Certain gaseous halides in halogenation step 1020″′ may be cooled in condensers to form solid or liquid metal halides. In the non-limiting example shown in FIG. 13b, gaseous metal halides from halogenation step 1020″′ may be cooled in staged condensation steps. As shown in FIG. 13b, gaseous metal halides from halogenation step 1020″′ may be cooled in first condensation step 1030′″, second condensation step 1032″′, third condensation step 1034′″, fourth condensation step 1039″, and fifth condensation step 1038′″, although fewer or more condensation steps may be used. First condensation step 1030′, second condensation step 1032″, third condensation step 1034″, fourth condensation step 1039″ and fifth condensation step 1038″′ may be performed in the same or different condensers. In certain embodiments, the condensers may be plate shell and tube plate, spray/quench, graphite block, falling film, packed bed, cold trap, or ceramic tube condensers. The condensation step temperatures may be adjusted based on the metal halides to be condensed. Each of these condensation temperatures may be adjusted to achieve a particular group of metal chlorides.

Following condensation, remaining gaseous halides may be water quenched in water quench step 1050′ to form an acid brine of halides. The remaining halides in the acid brine may be dried in drying step 1070′.

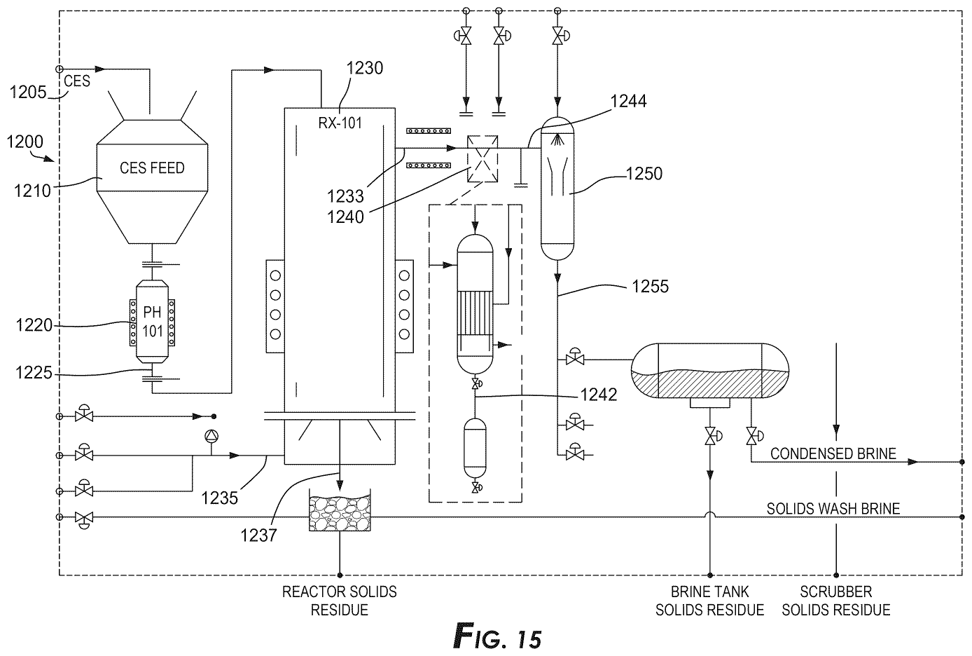

FIG. 14 is a block flow diagram of a process for recovering metals 1002 for a particular embodiment of process for recovering metals 1000. In the non-limiting embodiment shown in FIG. 14, the embodiment shown in FIG. 12 may be modified to remove certain condensers and use fractional distillation. In certain embodiments, a feedstock containing a metal may be introduced to the process for recovering metals 1002. Following feedback processing in feedstock processing step 1010″, the processed feedstock may be heated and combined with a halogen gas in one or more inductive heating reactors or inductive/ohmic heating reactors, or combinations thereof. In the embodiment shown in FIG. 14, halogenation of the feedstock may be performed in first halogenation step 1020″ and second halogenation step 1022″ in the manner described above. First halogenation step 1020″ may be performed at a first halogenation temperature and second halogenation step 1022″ may be performed at second halogenation temperature that is higher than the first halogenation temperature. By increasing halogenation temperatures, different metals may be halogenated in the different halogenation steps. First halogenation step 1020″ and second halogenation step 1022″ may be performed in the same or different reactors.

In certain embodiments, first halogenation step 1020″ may be performed at a first reactor temperature of between 600 °C and 700 °C or 650 °C. At this first reactor temperature, gaseous metal chlorides of gold, antimony, tin, aluminum, zinc, zirconium, lead, and titanium may be formed and separated from the processed feedstock, where such elements are present in the processed feedstock.

In the non-limiting embodiment shown in FIG. 14, heating step 1040″ may be performed between first halogenation step 1020″ and second halogenation step 1022″. In heating step 1040″, a previously halogenated feedstock may be heated to a heating temperature without adding halogens. Without being bound by theory, by heating the feedstock in heating step 1040″ to a heating temperature above that at which first halogenation step 1020″ is performed, certain compounds in the feedstock may decompose and form metal halides. In some embodiments, heating temperature may be between 1000 °C and 1200 °C, or 1100 °C. In such embodiments, the decomposing compounds may include compounds containing zinc, manganese, lead, titanium, and platinum, where such compounds are present in the processed feedstock. Gaseous halides of zinc, manganese, lead, titanium, and platinum may be formed.

Following heating step 1040″, second halogenation step 1022″ may be performed at a second reactor temperature of between 500 °C and 700 °C or 600 °C. At this second reactor temperature, metal chlorides of copper, chromium, palladium, nickel and magnesium may be formed and separated from the processed feedstock where such elements were present in the processed feedstock. Such further halogenation may form solid halides of copper, chromium, nickel and magnesium where such elements are present in the processed feedstock. The solid halides formed in second halogenation step 1022″ may be water quenched in water quench step 1050′ to form an acid brine of halides. In some embodiments, copper may be separated from the acid brine through electroreduction in electrowinning step 1060′. The remaining halides in the acid brine may be dried in drying step 1070′.

Gaseous halides from heating step 1040″ may be cooled in a condenser to form solid or liquid metal halides. In the non-limiting example shown in FIG. 14, heating condensation temperature for heating condensation step 1042″ may be set to between 400 °C and 700 °C or 600 °C to condense zinc, manganese, lead, titanium, platinum, chromium, and iron.

In the embodiment shown in FIG. 14, impurities condensation step 1080 may be used to remove impurities such as boron chloride, silicon chloride and the halogen from the gaseous metal halides resulting from first halogenation step 1020″ and to cool certain of the gaseous metal halides to form liquid/gaseous halides. Impurities condenser temperature may be between 20 °C and 40 °C or 30 °C. In other embodiments, impurities condensation step 1080 may be omitted. After impurities condensation step 1080, the gaseous metal halides may be heated in a furnace in furnace heating step 1090. Furnace heating step 1090 may heat the liquid/gaseous halides to form a molten metal halide stream. The molten metal halide stream may include dissolved metal halides. In certain embodiments, furnace heating temperature may be between 200 °C and 300 °C or 250 °C.

Following furnace heating step 1090, certain halides of the molten metal halide stream may be separated in fractional distillation step 1100. In the non-limiting example shown in FIG. 14, the molten metal halide stream may be separated into three molten streams-a molten stannous chloride stream that includes dissolved aluminum chloride and antimony chloride, a molten auric chloride stream with dissolved aluminum chloride, antimony chloride and iron chloride, and a molten iron chloride stream with dissolved aluminum chloride, antimony chloride and auric chloride. As one of ordinary skill in the art with the purpose of this disclosure will appreciate, temperatures at which fractional distillation step 1100 may be performed will depend upon the halogen and the desired separation.

FIG. 15 is a process flow diagram for metal extraction system 1200. Metal extraction system 1200 includes feed hopper 1210, which is connected to preheater 1220. Feed hopper 1210 may receive feedstream 1205. Feedstream 1205 may include feedstocks having metals such as ores, electronic waste, black mass, lanthanide concentrate, spodumene, bauxite residue (for example, red mud), coal fly ash, gold tailings, rare earth element tailings and fines, and production scrap from processes utilizing indium, gallium, or germanium. For example, rare earth element tailings and fines may be formed in mining and concentrating of rare earth bearing minerals, such as, for example and without limitation, bastnasite, monazite, ionic clay, and eudialyte. Such rare earth tailings and fines may include between, for example, 200 ppm and 25% by weight of a rare earth element, such as terbium, dysprosium, neodymium, Praseodymium, and scandium. The feedstocks, after passing through feed hopper 1210, may be heated in preheater 1220 to form heated feed 1225.

The feedstocks in heated feed 1225 may be introduced into reactor 1230. Reactor 1230 may be an inductive heating reactor or inductive/ohmic heating reactor. In certain embodiments, reactor 1230 may be lined, such as with a halogen-resistant liner. Examples of such halogen resistant liners include quartz, HFO₂, or ceramic liners. In the embodiment shown in FIG. 15, heated feed 1225 may be introduced into the top of reactor 1230, while halogen stream 1235 may be introduced into the bottom of reactor 1230. Halogen stream 1235 may include gaseous halogens, such as chlorine or fluorine. Within reactor 1230, the halogens may react with the metals in the feedstock to form gaseous metal halides, which exit reactor 1230 through product stream 1233. In certain embodiments, the pressure in reactor 1230 may be adjusted to volatilize the metal halides to form gaseous metal halides. Reactor solids residue stream 1237 may exit reactor 1230. Reactor solids residue stream may include unreacted feedstock and reacted feedstock that is not formed into gaseous metal halides.

Product stream 1233 may be cooled in condenser cooler 1240. Condenser cooler 1240 may be, for example, a plate condenser or as shown in FIG. 15, a shell and tube condenser. In other examples, condenser cooler 1240 may be a plate, spray/quench, graphite block, falling film, packed bed, cold trap, or ceramic tube condenser. Condenser cooler 1240 may also be a spray/quench, graphite block, falling film, packed bed, cold trap, and ceramic tube condenser. Condenser cooler 1240 may form liquid metal halides, which may exit condenser cooler 1240 in liquid metal halide stream 1242. Metal halides that do not liquify may exit condenser cooler 1240 through gaseous metal halide stream 1244. Gaseous metal halide stream 1244 may enter quench cooler 1250.

In quench cooler 1250, metal halides in gaseous metal halide stream 1244 may be cooled with water or other solvent and formed into a metal halide brine. The metal halide brine may include water or other solvent and metal halide salts. The metal halide brine may exit quench cooler 1250 through metal halide brine stream 1255.

Depending on the context, all references herein to the “disclosure” may in some cases refer to certain specific embodiments only. In other cases it may refer to subject matter recited in one or more, but not necessarily all, of the claims. While the foregoing is directed to embodiments, versions and examples of the present disclosure, which are included to enable a person of ordinary skill in the art to make and use the disclosures when the information in this patent is combined with available information and technology, the disclosures are not limited to only these particular embodiments, versions and examples. Other and further embodiments, versions and examples of the disclosure may be devised without departing from the basic scope thereof and the scope thereof is determined by the claims that follow.

1. A process for recovering metals comprising:
forming a processed feedstock, the processed feedstock including a first metal;
halogenating the processed feedstock at a first halogenating temperature to form a first gaseous metal halide stream, the first gaseous metal halide stream having a first metal halide, the first halogenating temperature selected based on the first metal; and
condensing a first portion of the first gaseous metal halide stream at a first condensing temperature, the first condensing temperature based on a first gaseous metal halide in the first gaseous metal halide stream.

2. The process of claim 1, wherein halogenating the processed feedstock is performed in an inductive heating reactor or inductive/ohmic heating reactor.

3. The process of claim 2, wherein the condensing the first gaseous metal halide is performed in a plate condenser.

4. The process of claim 3 further comprising after the step of halogenating the processed feedstock at the first halogenating temperature:
halogenating the processed feedstock at a second halogenating temperature to form a second gaseous halide steam having a second gaseous metal halide, wherein the second halogenating temperature is higher than the first halogenating temperature; and
condensing the second gaseous metal halide at a second condensing temperature, wherein the second condensing temperature is higher than the first condensing temperature.

5. The process of claim 4 further comprising after the step of halogenating the processed feedstock at the second halogenating temperature:
heating the processed feedstock to form a third gaseous metal halide at a heating temperature, wherein the heating temperature is higher than the second halogenating temperature; and
condensing the third gaseous metal halide at a heating condensing temperature, wherein the heating condensing temperature is higher than the second condensing temperature.

6. The process of claim 5, further comprising after the step of halogenating the processed feedstock at the heating temperature:
halogenating the processed feedstock to a third halogenation temperature to form a solid metal chloride; and
quenching the solid metal chloride with water to form an acid brine.

7. The process of claim 6 further comprising electrowinning the acid brine.

8. The process of claim 7 further comprising drying the acid brine.

9. The process of claim 3 further comprising condensing a second portion of the first gaseous metal halide stream at a second condensing temperature, the second condensing temperature lower than the first condensing temperature.

10. The process of claim 9 further comprising condensing a third portion of the first gaseous metal halide stream at a third condensing temperature, the third condensing temperature lower than the second condensing temperature.

11. The process of claim 3, wherein halogenating the processed feedstock at a first halogenating temperature is the only halogenation step in the process.

12. A process for recovering metals comprising:
forming a processed feedstock, the processed feedstock including a first metal;
halogenating the processed feedstock at a halogenating temperature to form a gaseous metal halide stream, the gaseous metal halide stream having a first metal halide and a second metal halide; and
distilling the gaseous metal halide stream to form a first fraction having the first metal halide and a second fraction having the second metal halide, wherein the first metal halide and the second metal halide are molten.

13. A process for recovering metals comprising:
halogenating a processed feedstock at a halogenating temperature to form a gaseous metal halide stream, the gaseous metal halide stream having a first metal halide and a second metal halide;
condensing a first portion of the gaseous metal halide stream at a condensing temperature, the condensing temperature based on the first metal halide; and
quench cooling a second portion of the gaseous metal halide to form a brine containing the second metal halide.

14. The process of claim 13, wherein the process of halogenating a process feedstock is performed in a inductive heating reactor or inductive/ohmic heating reactor.

15. The process of claim 13, wherein the step of condensing a first portion of the gaseous metal halide stream is performed in staged condensation steps.
